(19) United States
(12) Patent Application Publication
(10) Pub. No.: US 2008/0048927 A1
(43) Pub. Date: Feb. 28, 2008

(54) Variable directivity antenna and information processing device

(76) Inventor: Fumikazu Hoshi, Kanagawa (JP)

Correspondence Address: COOPER & DUNHAM, LLP, 1185 AVENUE OF THE AMERICAS, NEW YORK, NY, 10036, US

(21) Appl. No.: 11/895,328

(22) Filed: Aug. 23, 2007

(30) Foreign Application Priority Data
Aug. 25, 2006 (JP) 2006-229636

(51) Int. Cl. H01Q 9/00

(52) U.S. Cl. 343/850

(57) ABSTRACT

In a variable directivity antenna, an antenna element includes a pole-like or rotator-like radiator. A coaxial line supplies power to the antenna element. A directivity switching unit is provided in a junction between the antenna element and the coaxial line to change a directivity of the variable directivity antenna. At least one of an inside diameter of an outer conductor of the coaxial line in contact with the junction and a diameter of an inner conductor of the coaxial line in contact with the junction is provided to change a gain of the variable directivity antenna.

### BACKGROUND OF THE INVENTION

1. Field of the Invention

This invention relates to a variable directivity antenna which is capable of changing its directivity, and to an information processing device in which the variable directivity antenna is provided.

2. Description of the Related Art

With fast development of wireless-communication technology in these years, the products using wireless-communication technology have come to spread widely. It is demanded that the data-transmission capacity of wireless-communication channels be expanded. Recently, research and development aiming at expansion of the data-transmission capacity is actively carried out by multiplexing of signals covering various dimensions, including time, space, polarization, and codes.

It is considered that space multiplexing is realized by using an adaptive array antenna which is comprised of an array of antennas and a circuit which carries out vector composition of signals of the respective antennas. However, in the adaptive array antenna, the size of each antenna is large and/or the interval between the antennas is large, and the location to which the adaptive array antenna can be applied is restricted. Especially, for the purpose of using the antenna in mobile communication devices, it is desirable that the size of the antenna is as small as possible.

Usually, a variable directivity antenna has a variable directivity which can be changed by using a set of antennas and a power supply circuit. There is a possibility that the size of a variable directivity antenna be made smaller than that of the adaptive array antenna, and it is expected as a candidate of a miniaturized antenna which is capable of realizing space multiplexing. However, since there are few examples of the research for the miniaturization of a variable directivity antenna for the time being, there is a great demand for the development.

There are some related art documents which show a variable directivity antenna. For example, Japanese Laid-Open Patent Application No. 06-350334 discloses a variable directivity antenna which is capable of directing its directivity to a specific direction. FIG. 1 is a diagram showing an example of the variable directivity antenna disclosed in Japanese Laid-Open Patent Application No. 06-350334.

In the variable directivity antenna of FIG. 1, an opposing element 11 is arranged in the circumference of a radiating element (antenna element) 10 so that the opposing element 11 is in parallel with the radiating element 10. This opposing element 11 is mechanically rotatable around the radiating element 11 by using a directive control unit 12 which is comprised of a rotating unit 12a and a connecting arm 12b. The radiating element 10 and a power supply 15 are electrically connected by a coaxial feeder 14.

With the composition of this variable directivity antenna, it is possible to change the directivity of the antenna freely by changing the rotation angle of the reflective element 11 around the radiating element 11. However, the use of the opposing element 11 causes the size of the whole antenna to be excessively large.

Japanese Laid-Open Patent Application No. 10-154911 discloses an example of a variable directivity antenna which is capable of changing its directivity electrically. FIG. 2 is a diagram for explaining the principle of the variable directivity antenna disclosed in Japanese Laid-Open Patent Application No. 10-154911.

The variable directivity antenna of FIG. 2 includes a central drive element 22 arranged in the center of a disc-like grounding conductor 20 and a plurality of parasitic elements 24 arranged in the position which surrounds the central drive element 22 radially.

With the composition of this variable directivity antenna, the interval between the central drive element 22 and each parasitic element 24 is equivalent to about λ/4 value, and the size of the whole antenna is equal to or larger than 1.6λ.

An impedance load 26 in which one of a high impedance and a low impedance can be switched to the other is arranged on the bottom part of each parasitic element 24. The directivity of this antenna is changed by the switching of the impedance of the impedance load 26.

Japanese Laid-Open Patent Application No. 2001-024431 discloses a similar example of the variable directivity antenna. FIG. 3 is a diagram showing the example of the variable directivity antenna disclosed in Japanese Laid-Open Patent Application No. 2001-024431.

The variable directivity antenna of FIG. 3 includes a power-supply antenna element A0 arranged in the center of a disc-like grounding conductor 30 and a plurality of non-power-supply variable reactance elements A1-A6 arranged in the position which surrounds the power-supply antenna A0 radially.

With the composition of this variable directivity antenna, the interval d between the power-supply antenna element A0 and each of the non-power-supply variable reactance elements A1-A6 is equivalent to about λ/4 value, and the size of the whole antenna is equal to or larger than λ.

As mentioned above, in the variable directivity antenna according to the related art, the plurality of non-power-supply elements are arranged around the circumference of the radiating element, and the antenna directivity is controlled by using the electromagnetic interaction of the radiating element and the non-power-supply elements.

With the composition of the variable directivity antenna according to the related art, the equivalence composite opening of the antenna is enlarged, and the gain is increased. As a result, it is possible to control the directivity of the antenna. However, it is difficult in principle to reduce the size of the antenna to a size of a non-directional antenna.

To obviate the problem, it is necessary to provide a variable directivity antenna which changes the directivity of the antenna without enlarging the composite opening of the antenna, similar to that disclosed in Japanese Laid-Open Patent Application No. 2004-304785.

FIG. 4A and FIG. 4B show a variable directivity antenna disclosed in Japanese Laid-Open Patent Application No. 2004-304785. FIG. 4A is a cross-sectional view of this variable directivity antenna, and FIG. 4B is a top view of the dashed-line part of the variable directivity antenna of FIG. 4A.

The variable directivity antenna of FIG. 4A includes a power-supply coaxial line 41 which is comprised of an inner conductor 411 and an outer conductor 412, a rotator-like radiator 42 and a disc-like base plate 43. This variable directivity antenna includes an antenna element joined to the coaxial line 41 for power supply. And four short circuit lines 45 and four switches 44 are further connected at the joint between the coaxial line 41 and the radiator 42.

When all the four switches 44 are turned off, the radiation pattern of the antenna has no directivity. On the other hand, when only one of the four switches is turned on, the electric field in the coaxial line 41 is disturbed and the radiation pattern of the antenna has a directivity.

If one of the switches 44 is turned on to short-circuit the inner conductor 411 and the outer conductor 412 of the coaxial line, the high-order radiation mode, such as TE11, TE12, TE21, TE22, . . . in which the electric-field distribution is not axially symmetrical will occur within the coaxial line, in addition to the TEM mode in which the electric-field distribution is axially symmetrical. The directivity of the antenna is changed with occurrence of the high-order radiation mode.

In this composition, the directivity of the antenna can be changed by turning the switch ON and OFF. The composite opening of the antenna is not enlarged as in the variable directivity antennas shown in the above-mentioned related art documents, and the size of this antenna can be reduced to a size equivalent to that of a non-directional antenna.

Japanese Laid-Open Patent Application No. 2004-304785 discloses a variable directivity antenna in which the antenna directivity can be changed over a broad frequency band and the antenna size is reduced to a size equivalent to that of a non-directional antenna. See also the Technical Report AP2003-274 (2004) from the IEICE (Institute of Electronics, Information and Communication Engineers) of Japan, entitled “Proposal of Antenna Directivity Control Technology by Coaxial Short-Circuit Structure” by Sugawara, Hoshi, Hiroi, and Sato, which depicts the details of the variable directivity antenna disclosed in Japanese Laid-Open Patent Application No. 2004-304785.

However, the variable directivity antenna of Japanese Laid-Open Patent Application No. 2004-304785 has a problem that the directivity change quantity that can be obtained with the antenna is about 6 dB at its maximum as shown in FIG. 5.

FIG. 5 shows the frequency dependability of the directivity change quantity when one of the switches in the variable directivity antenna of FIG. 4 is turned on.

The directivity change quantity herein means a ratio of the maximum gain of the side where a gain with respect to the E surface directivity of an antenna is increased when the coaxial line is short-circuited, to the maximum gain of the opposite side where the gain is fallen when the coaxial line is short-circuited.

It is desirable that the directivity change quantity for practical use is on the order of 6-10 dB. Thus, the variable directivity antenna according to the related art does not provide adequate directivity change quantity.

### SUMMARY OF THE INVENTION

According to one aspect of the invention, there is provided an improved variable directivity antenna in which the above-described problems are eliminated.

According to one aspect of the invention there is provided a variable directivity antenna which has a large directivity change quantity over a broad band and has a size equivalent to that of a non-directional antenna.

In an embodiment of the invention which solves or reduces one or more of the above-mentioned problems, there is provided a variable directivity antenna comprising: an antenna element including a pole-like or rotator-like radiator; a coaxial line supplying power to the antenna element; a directivity switching unit provided in a junction between the antenna element and the coaxial line to change a directivity of the variable directivity antenna, wherein at least one of an inside diameter of an outer conductor of the coaxial line in contact with the junction and a diameter of an inner conductor of the coaxial line in contact with the junction is changed to change a gain of the variable directivity antenna.

The above-mentioned variable directivity antenna may be configured so that at least one of an annular conductor in contact with an inner circumference of the outer conductor and an annular conductor in contact with an outer circumference of the inner conductor is provided to change the gain of the variable directivity antenna.

The above-mentioned variable directivity antenna may be configured so that the antenna element is provided so that a diameter of a surface in contact with the junction is larger than a diameter of the inner conductor of the coaxial line, to change the gain of the variable directivity antenna.

The above-mentioned variable directivity antenna may be configured so that a first dielectric which comes in contact with an end of the coaxial line is provided in a circumference of the radiator to change the gain of the variable directivity antenna.

The above-mentioned variable directivity antenna may be configured so that a second dielectric which has a dielectric constant different from a dielectric constant between the outer conductor and the inner conductor of the coaxial line is provided at the end of the coaxial line to change the gain of the variable directivity antenna.

The above-mentioned variable directivity antenna may be configured so that the dielectric constant of the second dielectric is equal to a dielectric constant of the first dielectric.

The above-mentioned variable directivity antenna may be configured so that the directivity switching unit comprises a linear short circuit unit which is provided in the junction to short-circuit the inner conductor and the outer conductor of the coaxial line.

The above-mentioned variable directivity antenna may be configured so that any of the entire short circuit unit and a width or thickness of a part of the short circuit unit has a predetermined size.

According to an embodiment of the variable directivity antenna of the invention, the cut-off frequency of the coaxial line part in the junction between the antenna element and the coaxial line can be lowered, and the coupling quantity to the high-order radiation mode is increased at lower frequencies. Therefore, it is possible to provide a variable directivity antenna which has a large directivity change quantity over a broad band and has a size equivalent to that of a non-directional antenna.

According to an embodiment of the invention, it is possible to provide an information processing device which uses a variable directivity antenna having a large directivity change quantity over a broad band and having a size equivalent to that of a non-directional antenna.

### BRIEF DESCRIPTION OF THE DRAWINGS

Other objects, features and advantages of the present invention will be apparent from the following detailed description when reading in conjunction with the accompanying drawings.

FIG. 1 is a perspective view of an antenna according to the related art.

FIG. 2 is a perspective view of an antenna according to the related art.

FIG. 3 is a perspective view of an antenna according to the related art.

FIG. 4A is a cross-sectional view showing the composition of a variable directivity antenna according to the related art.

FIG. 4B is a top view of the dashed-line part of the variable directivity antenna of FIG. 4A.

FIG. 5 is a diagram for explaining the frequency dependability of the directivity change quantity the variable directivity antenna of FIG. 4A when one of the switches therein is turned on.

FIG. 6A is a cross-sectional view showing the composition of a variable directivity antenna in an embodiment of the invention.

FIG. 6B is a top view of the dashed-line part of the variable directivity antenna of FIG. 6A.

FIG. 7A is a cross-sectional view of a variable directivity antenna having no feature of the above embodiment of the invention.

FIG. 7B is a top view of the dashed-line part of the variable directivity antenna of FIG. 7A.

FIG. 8 is a diagram for explaining the frequency dependability of the directivity change quantity of each of the variable directivity antennas of FIG. 6A and FIG. 7A.

FIG. 9A is a top view of the dashed-line part of the variable directivity antenna of FIG. 4A when a short circuit unit has a various width.

FIG. 9B is a diagram for explaining the frequency dependability of the directivity change quantity when the width of the short circuit unit is changed variously as shown in FIG. 9A.

FIG. 10A is a top view of the dashed-line part of the variable directivity antenna of FIG. 4A when a short circuit unit has a various width of its sector portion.

FIG. 10B is a diagram for explaining the frequency dependability of the directivity change quantity when the width of the sector portion of the short circuit unit is changed variously as shown in FIG. 10A.

FIG. 11A is a cross-sectional view showing the composition of a variable directivity antenna in an embodiment of the invention when a short circuit unit has a predetermined thickness at its coaxial line.

FIG. 11B is a diagram for explaining the frequency dependability of the directivity change quantity when the thickness of the short circuit unit at its coaxial line is changed as shown in FIG. 11A.

FIG. 12A is a cross-sectional view showing the composition of a variable directivity antenna in an embodiment of the invention when a short circuit unit has a predetermined thickness at its antenna element.

FIG. 12B is a diagram for explaining the frequency dependability of the directivity change quantity when the thickness of the short circuit unit at its antenna element is changed as shown in FIG. 12A.

FIG. 13A is a cross-sectional view showing the composition of a variable directivity antenna in an embodiment of the invention in which a part of the short circuit unit on the inner conductor of the coaxial line has a predetermined thickness at its antenna element.

FIG. 13B is a diagram for explaining the frequency dependability of the directivity change quantity when the thickness of the part of the short circuit unit at the inner conductor of the coaxial line is changed to the antenna element side as shown in FIG. 13A.

FIG. 14A is a cross-sectional view showing the composition of a variable directivity antenna in an embodiment of the invention.

FIG. 14B is a top view of the dashed-line part of the variable directivity antenna of FIG. 14A.

FIG. 15A is a cross-sectional view of a variable directivity antenna having no feature of the above embodiment of the invention.

FIG. 15B is a top view of the dashed-line part of the variable directivity antenna of FIG. 15A.

FIG. 16 is a diagram for explaining the frequency dependability of the directivity change quantity in each of the variable directivity antenna of FIG. 14A and the variable directivity antenna of FIG. 15A.

FIG. 17A is a cross-sectional view of a variable directivity antenna in an embodiment of the invention.

FIG. 17B is a top view of the dashed-line part of the variable directivity antenna of FIG. 17A.

FIG. 18 is a diagram for explaining the frequency dependability of the directivity change quantity of the variable directivity antenna of FIG. 17A.

FIG. 19A is a cross-sectional view of a variable directivity antenna in an embodiment of the invention.

FIG. 19B is a top view of the dashed-line part of the variable directivity antenna of FIG. 19A.

FIG. 20 is a diagram for explaining the frequency dependability of the directivity change quantity of the variable directivity antenna of FIG. 19A.

FIG. 21 is a diagram showing an example of an information processing device including the variable directivity antenna of the invention.

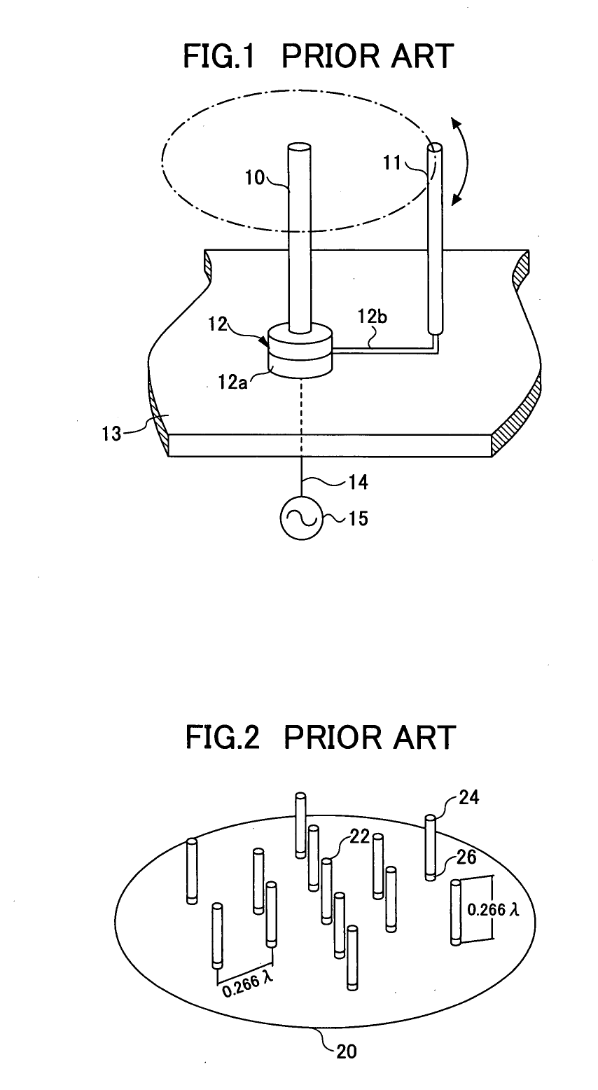

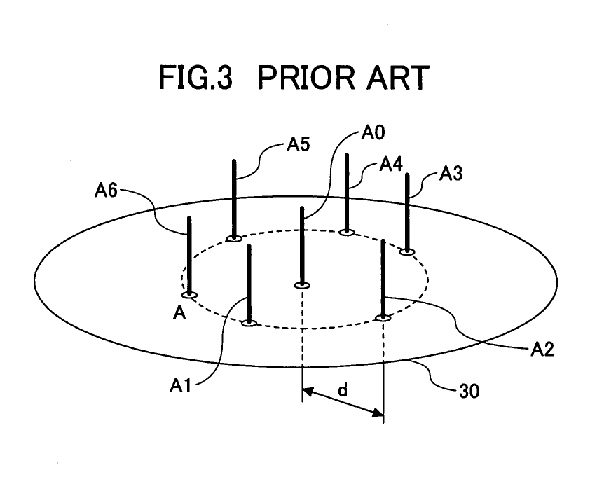

### DETAILED DESCRIPTION OF PREFERRED EMBODIMENTS

A description will be given of embodiments of the invention with reference to the accompanying drawings.

### Embodiment 1

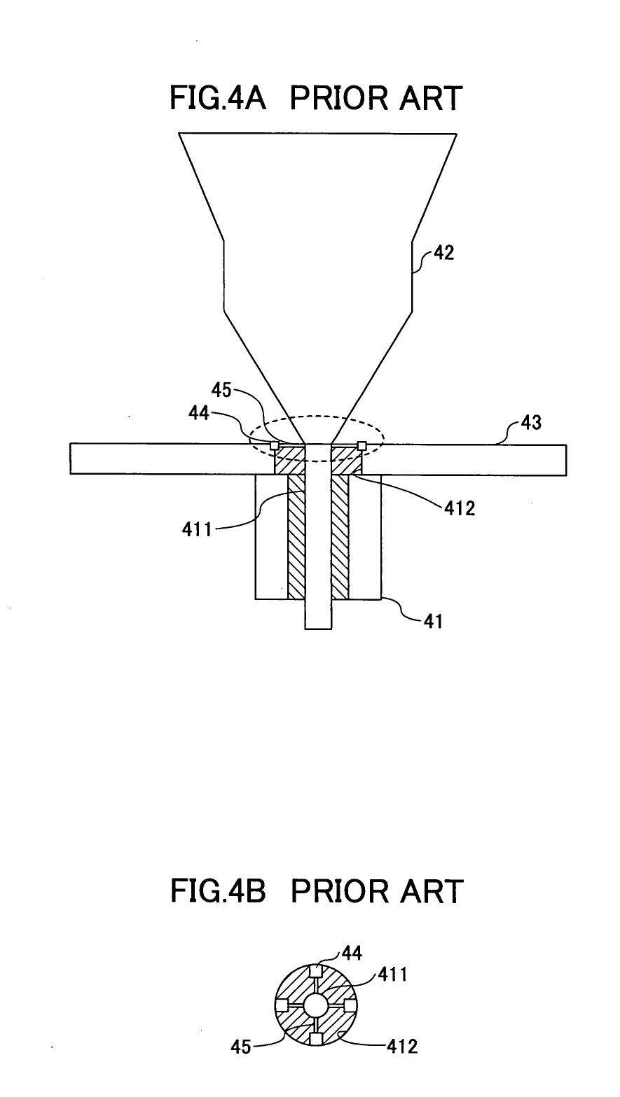

As explained with reference to FIG. 4A, the high-order radiation modes occur in the coaxial line and the antenna directivity changes in the variable directivity antenna according to the related art. Each of the high-order radiation modes corresponds to the cut-off frequency determined by the structure of the coaxial line.

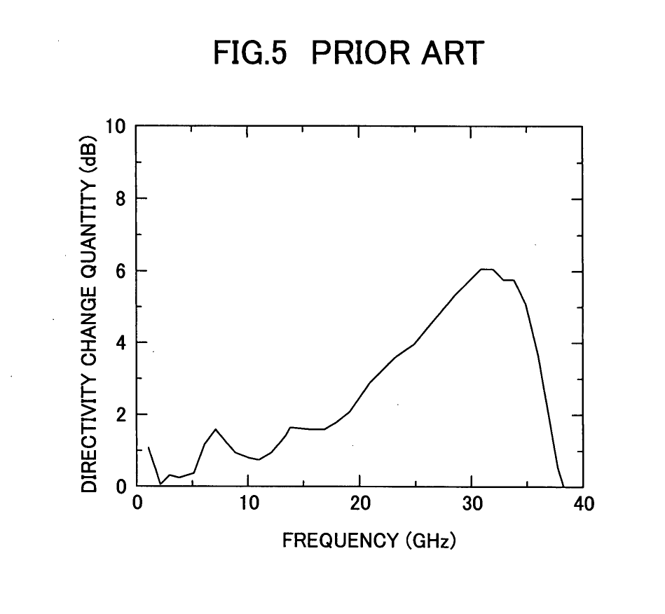

For example, as shown in the diagram of FIG. 5, the frequency dependability of the directivity change quantity has correlation to the cut-off frequency of the high-order radiation mode. At frequencies lower than the cut-off frequency, the directivity change quantity decreases. This is because the coupling quantity to the high-order radiation mode is decreased with the fall of frequencies lower than the cut-off frequency.

Therefore, improving the variable directivity antenna of the related art so as to lower the cut-off frequency of the coaxial line part in the joint between the antenna element and the coaxial line makes it possible that the coupling quantity to the high-order radiation mode is increased at lower frequencies and that the directivity change quantity is increased.

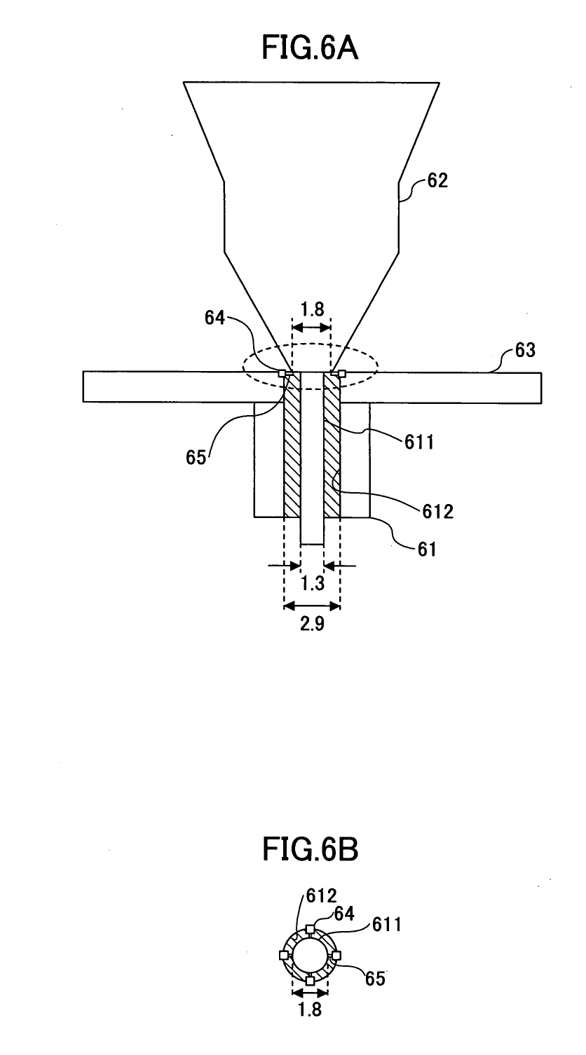

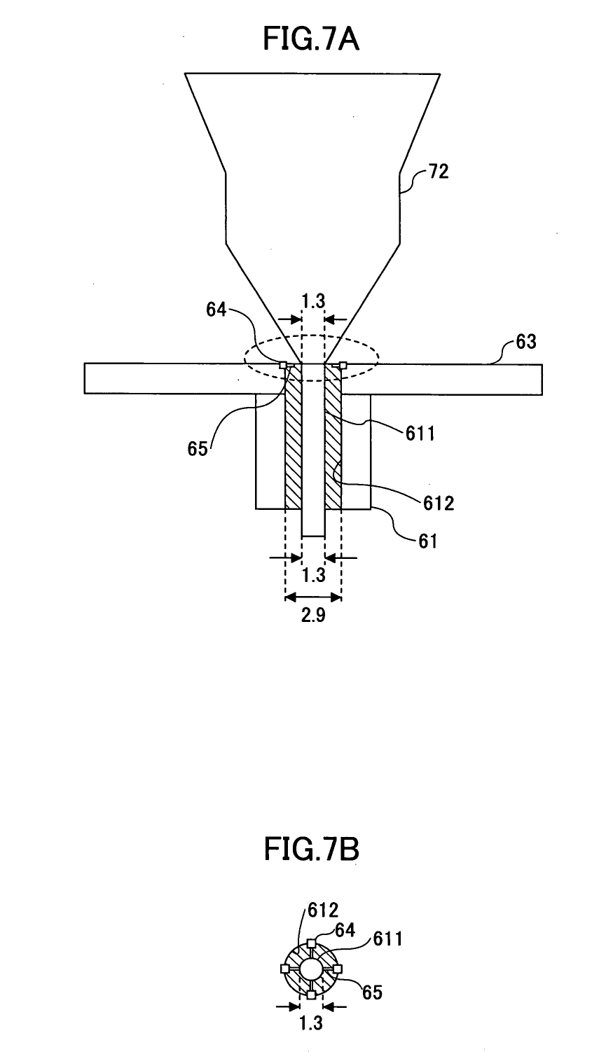

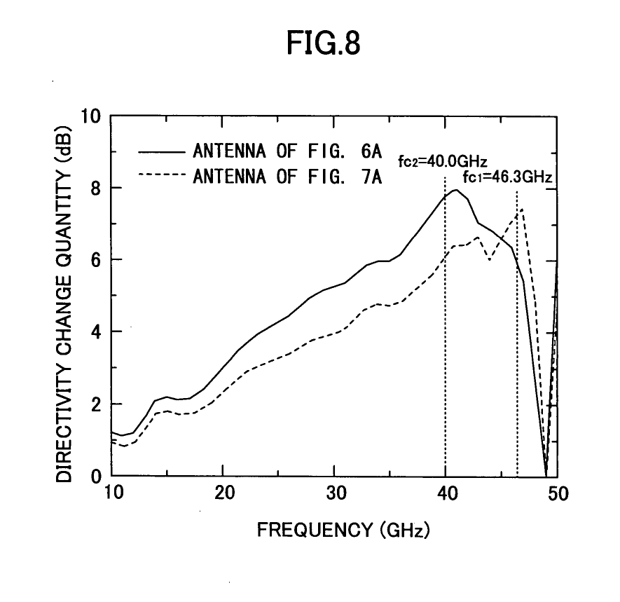

FIG. 6A and FIG. 6B show the composition of a variable directivity antenna in an embodiment of the invention. FIG. 6A is a cross-sectional view of the variable directivity antenna, and FIG. 6B is a top view of the dashed-line part of the variable directivity antenna of FIG. 6A.

The variable directivity antenna of FIG. 6A includes a coaxial line 61 which has an inner conductor 611 and an outer conductor 612, an antenna element which has a rotator-like radiator 62 and a disc-like base plate 63, and a directivity switching unit which changes the directivity of the variable directivity antenna.

The antenna element is bonded to the coaxial line 61 for power supply. The directivity switching unit is provided in the joint between the coaxial line 61 and the antenna element (radiator 62). The directivity switching unit includes a plurality of short circuit units 65 which are arranged to short-circuit the inner conductor 611 and the outer conductor 612 of the coaxial line 61 in four directions, and a plurality of switching units 64 which are arranged in the middle of the short circuit units 65.

Each switching unit 64 is a switch which is made of a PIN diode. Each switching unit 64 has the function to electrically short-circuit the inner conductor 611 and the outer conductor 612 of the coaxial line 61 via the short circuit unit 65 when it is turned on and off. The short circuit unit 65 has a line shape, and its width and thickness are negligible.

The radiator 62 is formed so that a diameter of the lower end of the radiator 62 in contact with the coaxial line 61 is larger than a diameter of the inner conductor 611 of the coaxial line 61. As is apparent from FIG. 6B, with the above-mentioned structure, the diameter of the inner conductor 611 of the coaxial line 61 in the joint between the coaxial line 61 and the antenna element is larger than the actual diameter of the inner conductor 611.

In the variable directivity antenna of this embodiment, the diameter of the inner conductor 611 and the inside diameter of the outer conductor 612 of the coaxial line 61 are equal to 1.3 mm and 2.9 mm, respectively. And the dielectric material which is provided between the inner conductor 611 and the outer conductor 612 is air (specific inductive capacity 1.0).

The diameter of the lower end of the radiator 62 in contact with the coaxial line 61 is equal to 1.8 mm, and it is larger than the diameter (1.3 mm) of the inner conductor 611 of the coaxial line 61.

In this embodiment, the diameter of the inner conductor 611 of the coaxial line 61 in the joint between the coaxial line 61 and the antenna element (radiator 62) is enlarged, and it is possible to lower the cut-off frequency of the high-order radiation mode.

Specifically, the main cut-off frequency in the TE11 mode in the high-order radiation mode is equal to fc1=46.3 GHz at the location of the coaxial line, but it falls to fc2=40.0 GHz at the location of the junction.

Various parameters, such as specific numeric values of the size of each of the above-mentioned component parts and their configurations, are determined based on the optimization design.

A description will be given of a comparative example for better understanding of the above-mentioned effect of the variable directivity antenna of this embodiment.

FIG. 7A and FIG. 7B show a variable directivity antenna of a comparative example which has no feature of the variable directivity antenna of FIG. 6A. Namely, the diameter of the lower end of the radiator in contact with the coaxial line in the comparative example is equal to the diameter of the inner conductor of the coaxial line. FIG. 7A is a cross-sectional view of the variable directivity antenna of the comparative example, and FIG. 7B is a top view of the dashed-line part of the variable directivity antenna of FIG. 7A.

The variable directivity antenna of FIG. 7A is constituted to have the structure that is the same as that of the variable directivity antenna of FIG. 6A, except that the diameter of the lower end of the radiator 72 in contact with the coaxial line 611 which is equal to 1.3 mm that is the same as the diameter of the inner conductor 611 of the coaxial line 61.

With this structure, the cut-off frequency of the high-order radiation mode in the joint between the coaxial line 61 and the antenna element (radiator 72) in the comparative example is equal to the cut-off frequency fc1 (=46.3 GHz) at the location of the coaxial line.

FIG. 8 is a diagram for explaining the frequency dependability of the directivity change quantity of each of the variable directivity antennas of FIG. 6A and FIG. 7A.

In FIG. 8, the vertical axis expresses the directivity change quantity (dB), and the horizontal axis expresses the frequency (GHz). In the diagram of FIG. 8, the dashed line shows the characteristic of the variable directivity antenna of FIG. 7A, and the solid line shows the characteristic of the variable directivity antenna of the embodiment of FIG. 6A.

As is apparent from FIG. 8, when compared with the variable directivity antenna of FIG. 7A having no feature of the embodiment of FIG. 6A, the variable directivity antenna in the embodiment of FIG. 6A shows that the peak frequency where the directivity change quantity is the maximum is shifted to the low frequency side, and the directivity change quantity is increased over a broad band (mainly on the low frequency side).

This is because the cut-off frequency of the high-order radiation mode in the joint between the coaxial line and the antenna element in the embodiment of FIG. 6A has fallen as mentioned above.

As described in the foregoing, the diameter of the inner conductor of the coaxial line in the joint between the coaxial line and the antenna element in the embodiment of FIG. 6A is increased, and it is possible to lower the cut-off frequency of the high-order radiation mode while the size equivalent to that of a non-directional antenna is maintained. As a result, it is possible to expand the directive variable band to the low frequency side and increase the directivity change quantity over a broad band.

Meanwhile, the cut-off frequency of the high-order radiation mode of the coaxial line is determined by not only the diameter of the inner conductor of the coaxial line, but also the dielectric constant of a dielectric material provided between the outer conductor and the inner conductor, or the diameter of the outer conductor of the coaxial line. Therefore, it is possible to lower the cut-off frequency by changing one or more of these elements: the diameter of the inner conductor; the dielectric constant of the dielectric material; and the diameter of the outer conductor.

### Embodiment 2

In this invention, the following study has been conducted paying attention to changes in the directivity change quantity when the width or the thickness of a short circuit unit provided between the inner conductor and the outer conductor of the coaxial line is changed.

This short circuit unit is formed in a surface perpendicular to the direction of travel of electromagnetic waves transmitting in the coaxial line. The width of the short circuit unit is the length thereof within the surface perpendicular to the direction of travel of the electromagnetic waves transmitting in the coaxial line. The thickness of the short circuit unit is the length thereof in the direction of travel of the electromagnetic waves transmitting in the coaxial line.

[Changing Width of Short Circuit Unit]

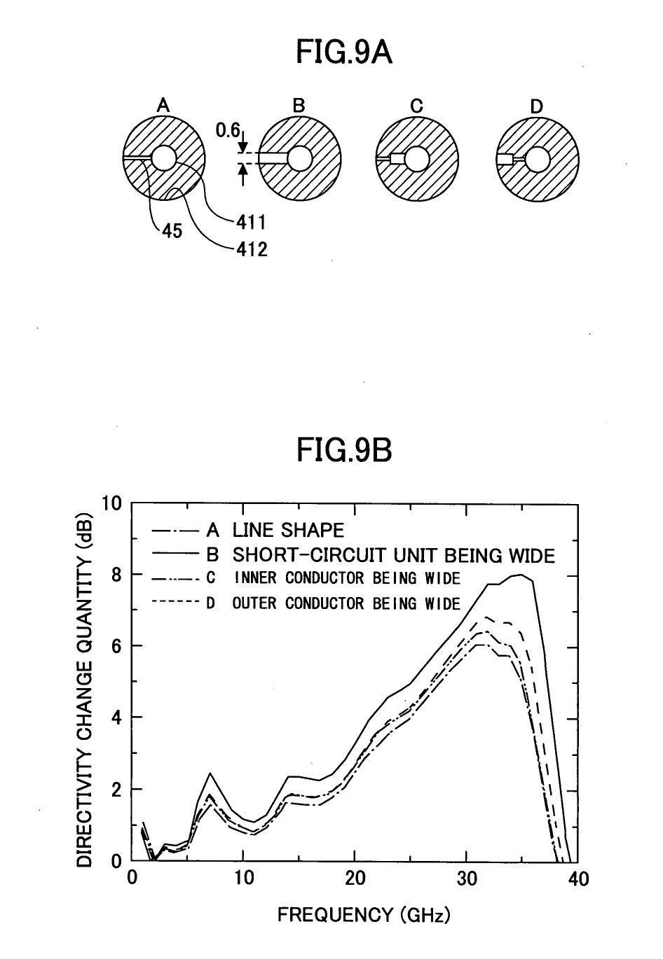

FIG. 9A and FIG. 9B show the frequency dependability of the directivity change quantity at the time of changing the width of a short circuit unit in the variable directivity antenna shown in FIG. 4A.

FIG. 9A is a top view of the dashed-line part of the variable directivity antenna of FIG. 4A when a short circuit unit has a various width. FIG. 9B is a diagram for explaining the frequency dependability of the directivity change quantity when the width of the short circuit unit is changed variously as shown in FIG. 9A. The vertical axis expresses the directivity change quantity (dB), and the horizontal axis the expresses frequency (GHz).

There are illustrated in FIG. 9A the four configurations: A) the short-circuit unit 45 having a line shape (the related art); B) the entire short-circuit unit 45 having a width of 0.6 mm; C) the inner conductor of the coaxial line having a width of 0.6 mm; and D) the outer conductor of the coaxial line having a width of 0.6 mm.

As is apparent from the diagram of FIG. 9B, changing the width of the entire short circuit unit 45 increases the directivity change quantity to a level larger than that in the case of the short circuit unit 45 having a line shape. Also when the width of the inner conductor or the outer conductor of the coaxial line is increased, the directivity change quantity is increased to a level larger than that in the case of the short circuit unit 45 having a line shape.

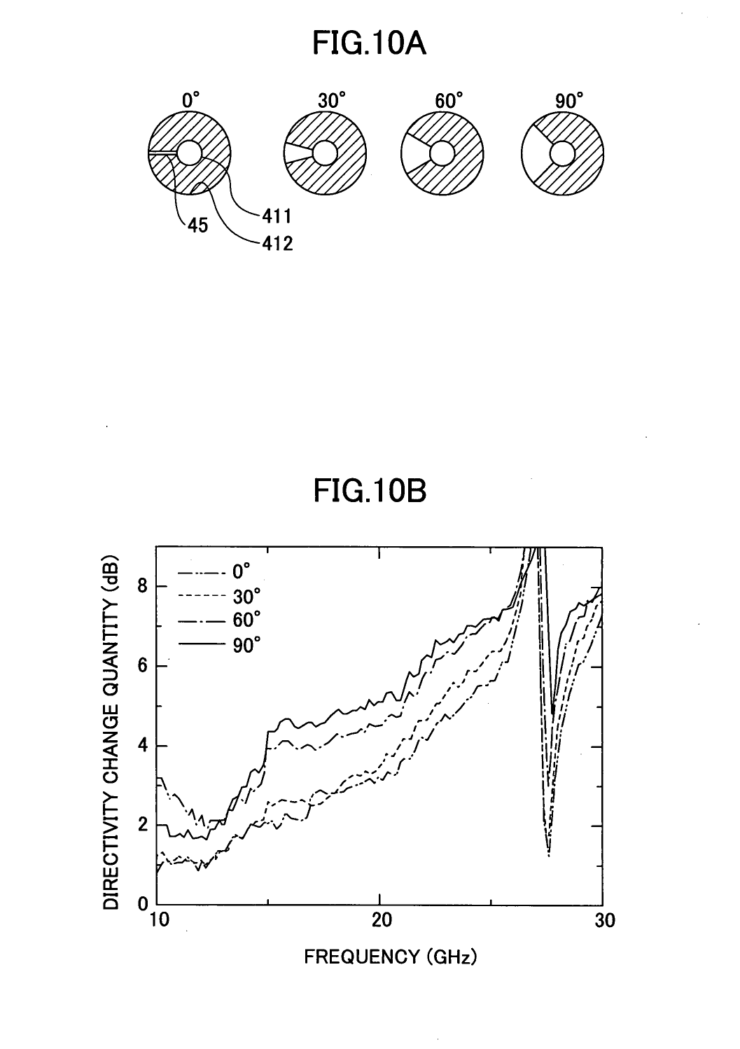

FIG. 10A and FIG. 10B show the frequency dependability of the directivity change quantity when the opening angle of the short circuit unit in the variable directivity antenna of FIG. 4A is changed and the width of the sector portion of the short circuit unit is changed.

FIG. 10A is a top view of the dashed-line part of the variable directivity antenna of FIG. 4A when the width of the sector portion of the short circuit unit is changed variously. FIG. 10B is a diagram for explaining the frequency dependability of the directivity change quantity when the width of the sector portion of the short circuit unit is changed variously as shown in FIG. 10A. The vertical axis expresses the directivity change quantity (dB), and the horizontal axis expresses the frequency (GHz). There are illustrated in FIG. 10B the four configurations: the opening angle of the short circuit unit 45 is changed to 0 degrees, 30 degrees, 60 degrees, and 90 degrees respectively.

As is apparent from the diagram of FIG. 10B, when the width of the sector portion of the short circuit unit 45 is enlarged, the directivity change quantity is increased accordingly.

[Changing Thickness of Short Circuit Unit]

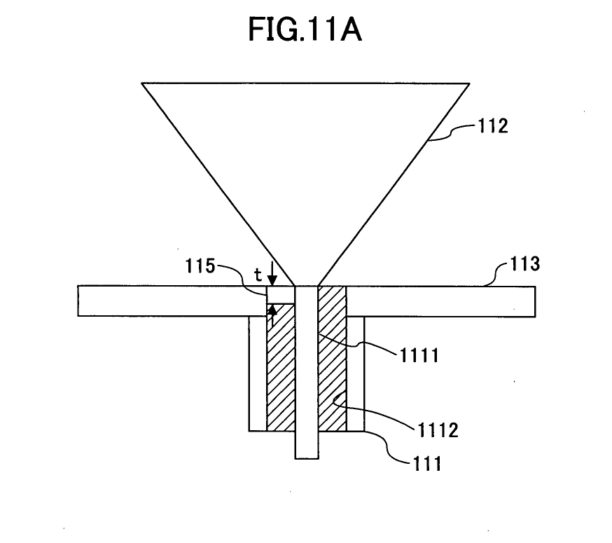

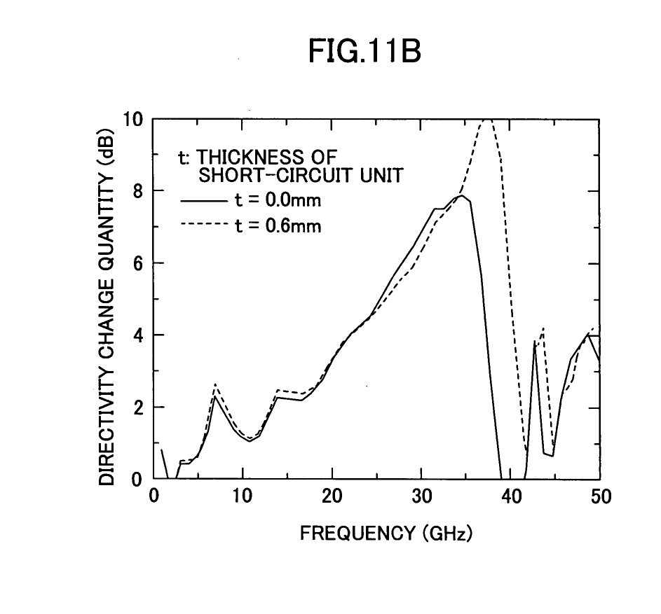

FIG. 11A and FIG. 11B show the frequency dependability of the directivity change quantity of a variable directivity antenna in an embodiment of the invention when a short circuit unit has a predetermined thickness at its coaxial line.

FIG. 11A is a cross-sectional view showing the composition of the variable directivity antenna of this embodiment in which the short circuit unit has a predetermined thickness at the coaxial line. FIG. 11B is a diagram for explaining the frequency dependability of the directivity change quantity when the thickness of the short circuit unit at the coaxial line is changed as shown in FIG. 11A. The vertical axis expresses the directivity change quantity (dB), and the horizontal axis expresses the frequency (GHz).

The variable directivity antenna of FIG. 11A includes a coaxial line 111 for power supply which has an inner conductor 1111 and an outer conductor 1112, and an antenna element which has a rotator-like radiator 112 and a disc-like base plate 113 and is bonded to the coaxial line 111 for power supply. The variable directivity antenna of FIG. 11A includes a short circuit unit 115 which is arranged to short-circuit the inner conductor 1111 and the outer conductor 1112 of the coaxial line 111, and has a predetermined thickness t.

As is apparent from the diagram of FIG. 11B, the thickness t of the short circuit unit 115 is increased (in this example, t=0.6 mm), and the peak frequency where the directivity change quantity is the maximum is shifted to the high-frequency side. And it is turned out that the maximum of the directivity change quantity increases only in the vicinity of the peak frequency. However, there is no effect of increasing the directivity change quantity over a broad band.

The peak frequency of the directivity change quantity has correlation with the length of the resonator when the high-order radiation mode occurring in the short circuit unit between inner conductor 1111 and outer conductor 1112 of the coaxial line is resonant within the coaxial line. It should be noted that the change of the peak frequency shown in the diagram of FIG. 11B, and the change of the directivity change quantity accompanied therewith are caused by the change of the length of the resonator inside the coaxial line when the thickness of the short circuit unit is changed to the coaxial-line side. It should be noted that changing the thickness of the short circuit unit to the coaxial-line side does not necessarily result in a special effect.

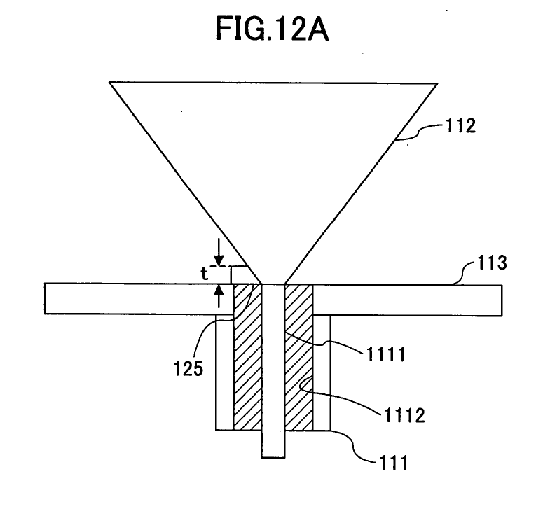

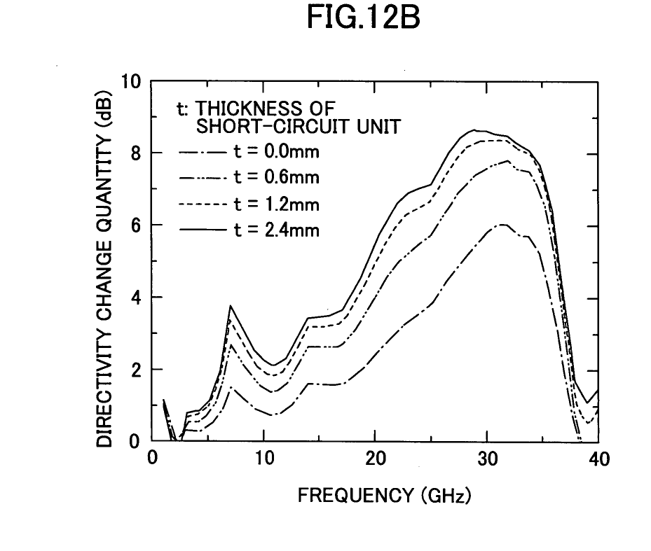

FIG. 12A and FIG. 12B show the frequency dependability of the directivity change quantity in a variable directivity antenna in an embodiment of the invention when a short circuit unit has a predetermined thickness at its antenna element. FIG. 12A is a cross-sectional view showing the of the variable directivity antenna of this embodiment in which the short circuit unit has a predetermined thickness at its antenna element. FIG. 12B is a diagram for explaining the frequency dependability of the directivity change quantity when the thickness of the short circuit unit at the antenna element is changed as shown in FIG. 12A. The vertical axis expresses the directivity change quantity (dB), and the horizontal axis the expresses frequency (GHz).

The variable directivity antenna of FIG. 12A is constituted to have the structure that is essentially the same as that of the variable directivity antenna of FIG. 11A, except that the short circuit unit 125 has a predetermined thickness t at the antenna element (radiator 112) side.

As is apparent from the diagram of FIG. 12B, when the thickness t of the short circuit unit 125 at the antenna element side is increased to 0.6 mm, 1.2 mm, and 2.4 mm, the directivity change quantity is increased over a broad band accordingly.

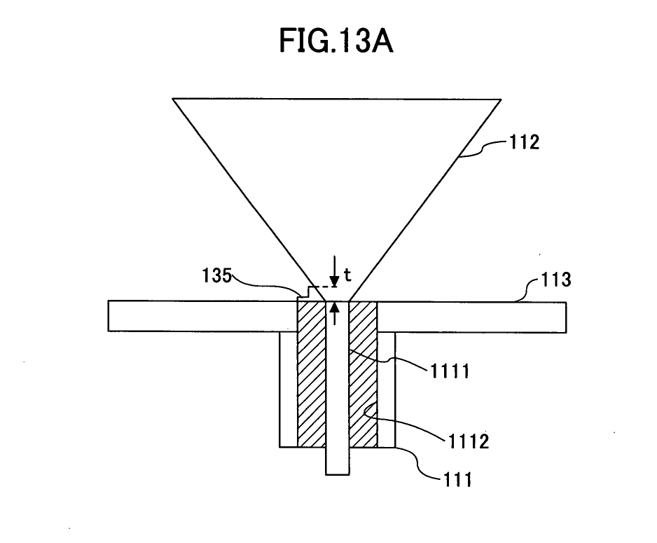

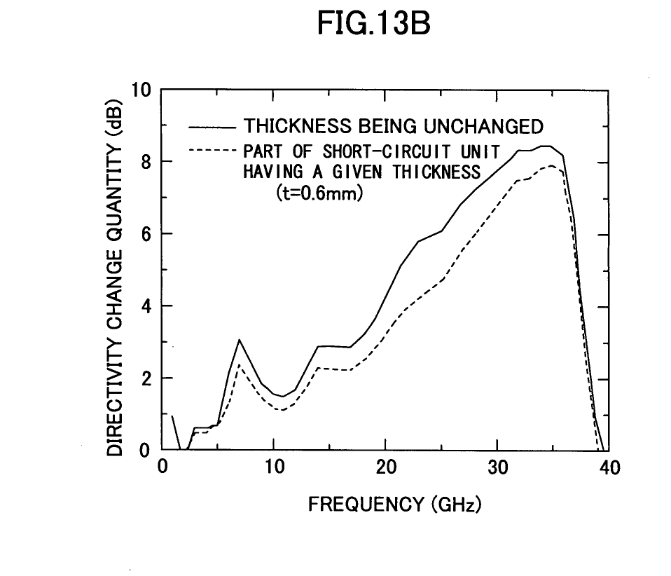

FIG. 13A and FIG. 13B show the frequency dependability of the directivity change quantity in a variable directivity antenna in an embodiment of the invention when a part of the short circuit unit on the side of the inner conductor of the coaxial line has a predetermined thickness at the antenna element side.

FIG. 13A is a cross-sectional view showing the composition of the variable directivity antenna of this embodiment in which a part of the short circuit unit on the side of the inner conductor of the coaxial line has a predetermined thickness at the antenna element side. FIG. 13B is a diagram for explaining the frequency dependability of the directivity change quantity when the thickness of the part of the short circuit unit on the side of the inner conductor of the coaxial line is changed at the antenna element side as shown in FIG. 13A. The vertical axis expresses the directivity change quantity (dB), and the horizontal axis expresses the frequency (GHz).

The variable directivity antenna of FIG. 13A is constituted to have the structure that is essentially the same as that of the variable directivity antenna of FIG. 11A except that the part of the short circuit unit 135 on the inner conductor side of the coaxial line has a predetermined thickness t at the antenna element (radiator 112) side.

As is apparent from the diagram of FIG. 13B, changing the thickness of the part of the short circuit unit (in this example, t=0.6 mm), instead of changing the thickness of the entire short circuit unit as in the variable directivity antenna of FIG. 12A, is more effective in increasing the directivity change quantity over a broad band.

As described in the foregoing, it becomes apparent that increasing either the width of the short circuit unit arranged to short-circuit the inner conductor and the outer conductor of the coaxial line, or the thickness of the short circuit unit at the antenna element side in this embodiment is effective in increasing the directivity change quantity over a broad band.

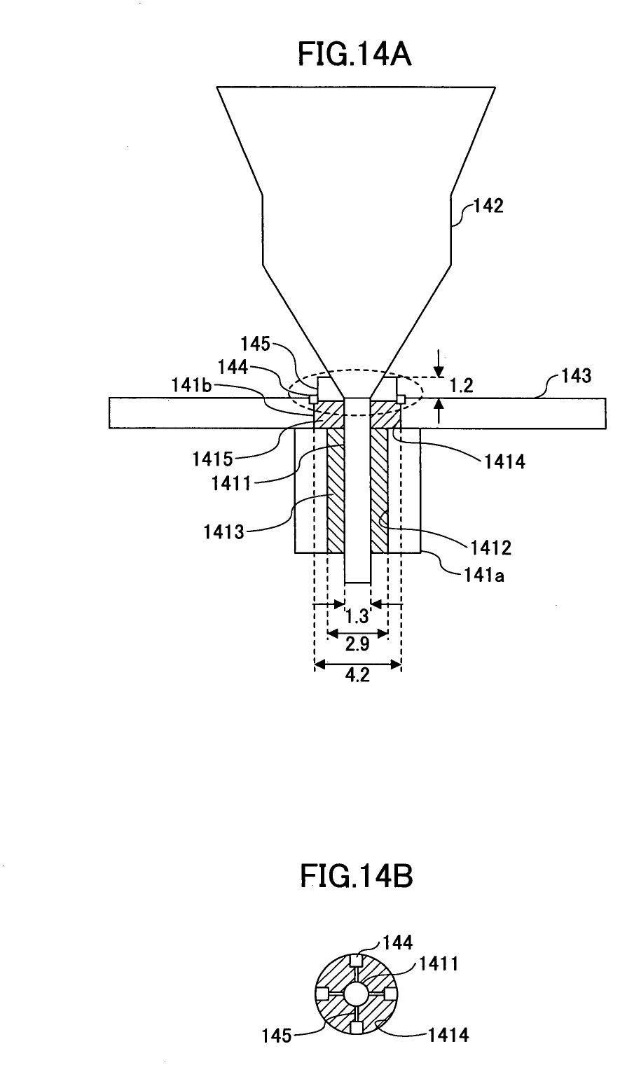

FIG. 14A and FIG. 14B show the composition of a variable directivity antenna in an embodiment of the invention. FIG. 14A is a cross-sectional view of the variable directivity antenna. FIG. 14B is a top view of the dashed-line part of the variable directivity antenna of FIG. 14A.

The variable directivity antenna of FIG. 14A is provided to include two coaxial lines for power supply, an antenna element, and a directivity switching unit. The two coaxial lines are first and second coaxial lines 141a and 141b. The first coaxial line 141a includes a common inner conductor 1411 and an outer conductor 1412. The second coaxial line 141b includes the common inner conductor 1411 and an outer conductor 1414. The outer conductors 1412 and 1414 have inside diameters that are different from each other. The antenna element includes a rotator-like radiator 142 and a disc-like base plate 143, and is bonded to the second coaxial line 141b for power supply. The directivity switching unit changes the directivity of this variable directivity antenna.

The directivity switching unit includes a plurality of short circuit units 145 and a plurality of switching units 144. The short circuit units 145 are arranged in the joint between the second coaxial line 141b and the radiator 142 to short-circuit the inner conductor 1411 and the outer conductor 1414 of the second coaxial line 141b in four directions. The switching units 144 are arranged in the middle of the short circuit units 145.

Each switching unit 144 is a switch which is made of a PIN diode, and has the function to short-circuit electrically the inner conductor 1411 and the outer conductor 1414 of the second coaxial line 141b via the short circuit unit 145 when the switch is turned on and off.

The short circuit unit 145 in this embodiment has a predetermined thickness (=1.2 mm) and its width is negligible.

In the variable directivity antenna of this embodiment, the diameter of the inner conductor 1411 and the inside diameter of the outer conductor 1412 of the first coaxial line 141a are equal to 1.3 mm and 2.9 mm, respectively, and the dielectric material 1413 which is provided between the inner conductor 1411 and the outer conductor 1412 is air (its specific inductive capacity is 1.0).

The inner conductor of the second coaxial line 141b is the same as the inner conductor 1411 of the first coaxial line 141a, and its diameter is equal to 1.3 mm. On the other hand, the inside diameter of the outer conductor 1414 is equal to 4.2 mm, which is larger than the inside diameter (=2.9 mm) of the outer conductor 1412 of the first coaxial line 141a. The dielectric material 1415 which is provided between the inner conductor 1411 and the outer conductor 1414 of the second coaxial line 141b is not air but Teflon (registered trademark), and its specific inductive capacity is 2.0.

In this embodiment, the diameter of the lower end section of the radiator 142 in contact with the second coaxial line 141b is equal to 1.3 mm which is the same as the diameter of the inner conductor 1411 of the second coaxial line 141b. Alternatively, the diameter of the inner conductor 1411 in the joint between the coaxial line and the radiator may be enlarged so that it is larger than the actual diameter of the inner conductor.

Various parameters, such as specific numeric values of the size of each of the above-mentioned component parts and their configurations, are determined based on the optimization design.

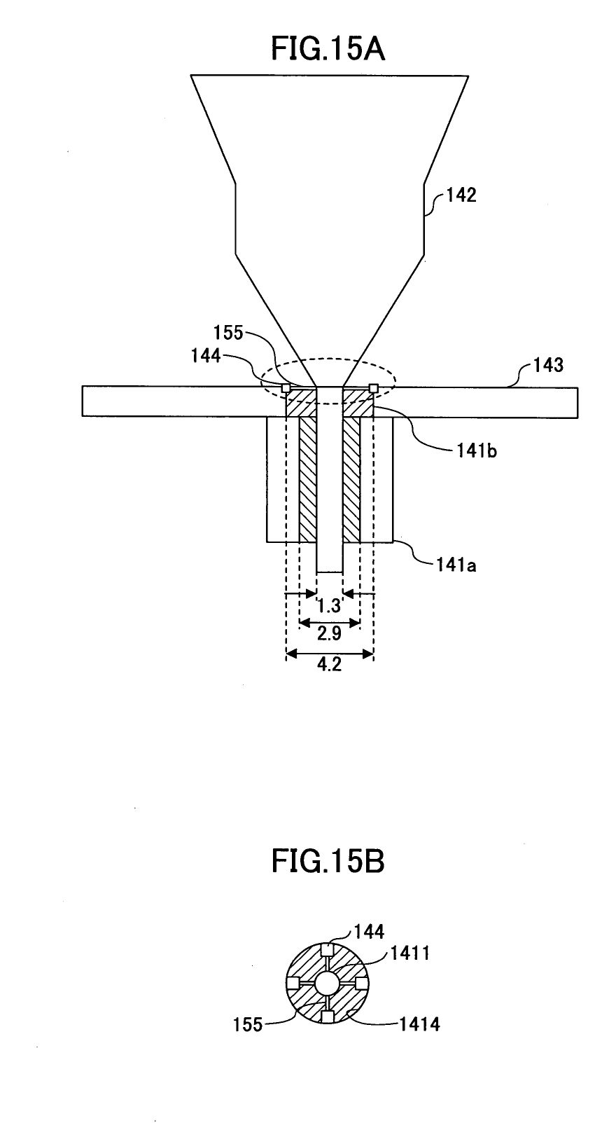

In order to provide better understanding of the effect of the variable directivity antenna of this embodiment, FIG. 15A and FIG. 15B show a variable directivity antenna having no feature of this embodiment. That is, the short circuit unit of this comparative example has a line shape and its thickness and width are negligible.

FIG. 15A is a cross-sectional view of the variable directivity antenna of the comparative example, and FIG. 15B is a top view of the dashed-line part of the variable directivity antenna of FIG. 15A.

The variable directivity antenna of FIG. 15A is the same as that of FIG. 14A except that it includes a linear short circuit unit 155 provided to short-circuit the inner conductor 1411 and the outer conductors 1414 of the second coaxial line 141b.

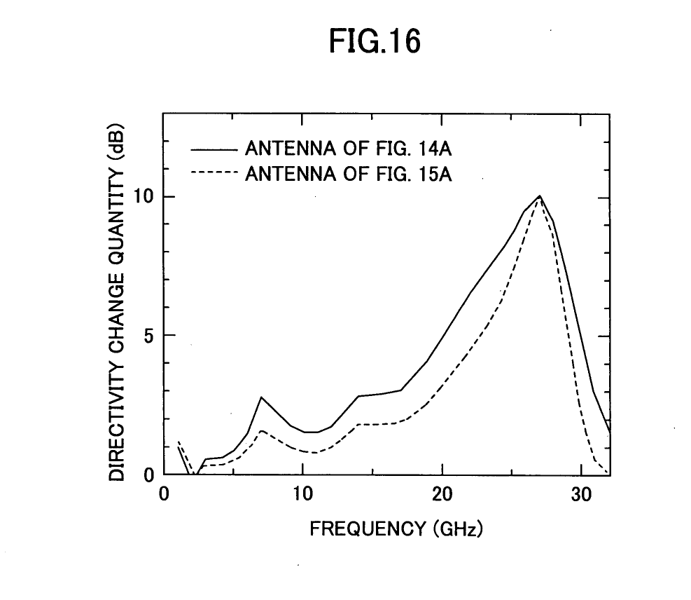

FIG. 16 is a diagram for explaining the frequency dependability of the directivity change quantity of each of the variable directivity antennas of FIG. 14A and FIG. 15A.

In the diagram of FIG. 16, the vertical axis expresses the directivity change quantity (dB), and the horizontal axis expresses the frequency (GHz). The solid line shows the characteristic of the variable directivity antenna of the embodiment of FIG. 14A, and the dashed line shows the characteristic of the variable directivity antenna of the comparative example of FIG. 15A.

As is apparent from the diagram of FIG. 16, when compared with the variable directivity antenna of FIG. 15A having no feature of this embodiment, the variable directivity antenna of the embodiment of FIG. 14A shows that the peak frequency where the directivity change quantity is the maximum remains unchanged, but shows that the directivity change quantity is increased over a broad band by about 1-2 dB.

As described in the foregoing, it is possible to increase the directivity change quantity over a broad band, maintaining a size equivalent to that of a non-directional antenna by increasing the thickness of the short circuit unit, which is provided to short-circuit the inner conductor and the outer conductor of the coaxial line, at the antenna element side.

### Embodiment 3

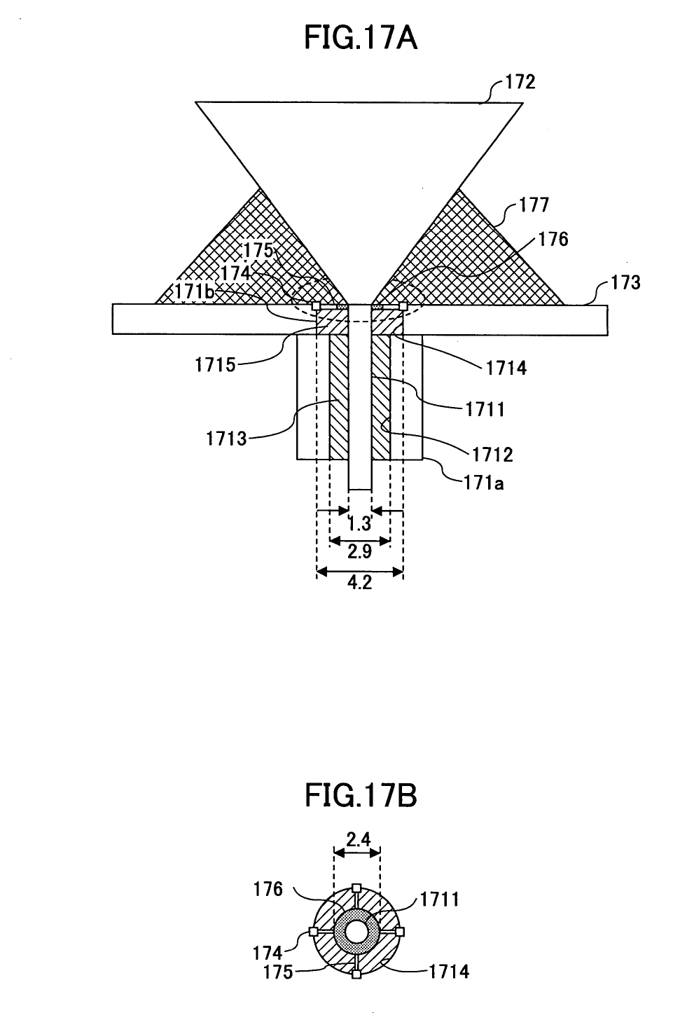

FIG. 17A and FIG. 17B show the composition of a variable directivity antenna in an embodiment of the invention. FIG. 17A is a cross-sectional view of this variable directivity antenna. FIG. 17B is a top view of the dashed-line part of the variable directivity antenna of FIG. 17A.

The variable directivity antenna of FIG. 17A is provided to include two coaxial lines, a non-directional antenna element, and a directivity switching unit. The two coaxial lines are first and second coaxial lines 171a and 171b. The first coaxial line 171a includes a common inner conductor 1711 and an outer conductor 1712. The second coaxial line 172a includes the common inner conductor 1711 and an outer conductor 1714. The outer conductors 1712 and 1714 have inside diameters that are different from each other. The non-directional antenna element includes a rotator-like radiator 172 and a base plate 173, and is bonded to the second coaxial line 171b for power supply. The directivity switching unit changes the directivity of this variable directivity antenna.

The directivity switching unit is provided to include a plurality of short circuit units 175 and a plurality of switching units 174. The short circuit units 175 are arranged in the joint between the second coaxial line 171b and the radiator 172 to short-circuit the inner conductor 1711 and the outer conductor 1714 of the second coaxial line 171b in four directions. The switching units 174 are arranged in the middle of the short circuit units 175.

Each switching unit 174 is a switch which is made of a PIN diode, and has the function to short-circuit electrically the inner conductor 1711 and the outer conductor 1714 of the second coaxial line 171b via the short circuit unit 175 when it is turned on and off. Each short circuit unit 175 has a line shape and its width and thickness are negligible.

In the variable directivity antenna of this embodiment, the diameter of the inner conductor 1711 of the first coaxial line 171a and the inside diameter of the outer conductor 1712 are equal to 1.3 mm and 2.9 mm, respectively. The dielectric material 1713 which is provided between the inner conductor 1711 and the outer conductor 1712 is air (its specific inductive capacity is 1.0).

The inner conductor of the second coaxial line 171b is the same as the inner conductor 1711 of the first coaxial line 171a, and its diameter is equal to 1.3 mm. On the other hand, the inside diameter of the outer conductor 1714 is equal to 4.2 mm, which is larger than the inside diameter (=2.9 mm) of the outer conductor 1712 of the first coaxial line 171a.

The dielectric material 1715 which is provided between the inner conductor 1711 and the outer conductor 1714 of the second coaxial line 171b is not air but Teflon (registered trademark) (its specific inductive capacity is 2.0).

In this embodiment, the diameter of the lower end of the radiator 172 in contact with the second coaxial line 171b is equal to 1.3 mm which is the same as the diameter of the inner conductor 1711 of the second coaxial line 171b.

Various parameters, such as specific numeric values of the size of each of the above-mentioned component parts and their configurations, are determined based on the optimization design.

As shown in FIG. 17B, the variable directivity antenna of this embodiment further includes an annular conductor 176 which is arranged at the end of the second coaxial line 171b in contact with the joint between the second coaxial line 171b and the radiator 172 so that the annular conductor 176 is in contact with the circumference of the inner conductor 1711 of the second coaxial line 171b.

As is apparent from FIG. 17B, the diameter of the inner conductor 1711 of the second coaxial line 171b in the joint between the coaxial line and the antenna element is enlarged, and it is possible to lower the cut-off frequency of the high-order radiation mode.

Specifically, the main cut-off frequency of the TE11 mode in the high-order radiation mode is fc1=25.2 GHz at the location of the second coaxial line 171b, but it falls to fc2=20.7 GHz at the location of the junction.

As mentioned above, the diameter of the inner conductor of the coaxial line in the joint between the coaxial line and the antenna element is enlarged, and it is possible to lower the cut-off frequency of the high-order radiation mode while maintaining the size equivalent to that of a non-directional antenna, and as a result the directivity change quantity can be increased over a broad band so that the directivity variable band may be expanded to the low frequency side.

Moreover, the variable directivity antenna of this embodiment includes a dielectric material 177 which is provided around the circumference of the radiator 172 so that the dielectric material 177 is in contact with the end of the second coaxial line 171b. The dielectric material 177 is made of a liquid crystal polymer, and its specific inductive capacity is equal to 3.0.

With this structure, it is possible to raise the higher-mode radiation ratio to the upper part of the contact part where the inner conductor 1711 and the outer conductor 1714 of the second coaxial line 171b are short-circuited by the short circuit unit 175, in order to increase the directivity change quantity over a broad band.

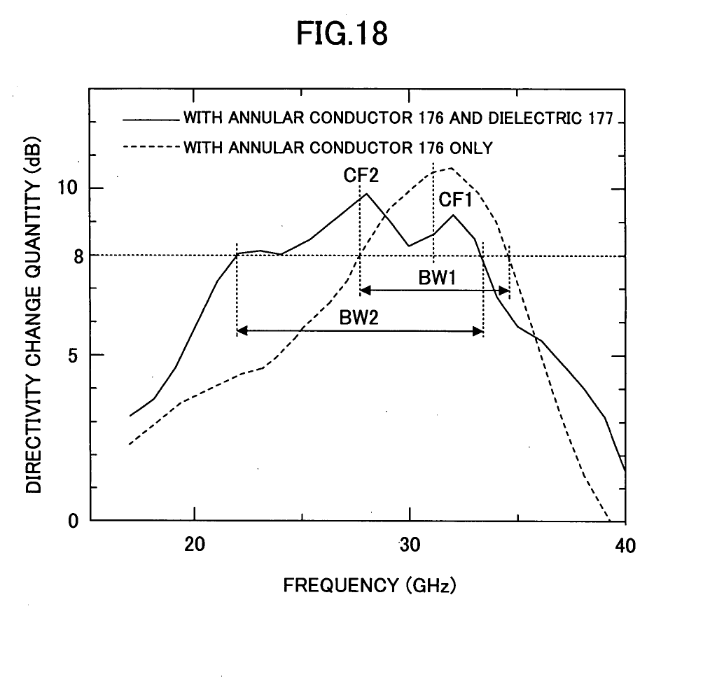

FIG. 18 is a diagram for explaining the frequency dependability of the directivity change quantity of the variable directivity antenna of FIG. 17A.

In the diagram of FIG. 18, the vertical axis expresses the directivity change quantity (dB), and the horizontal axis expresses the frequency (GHz). The solid line shows the characteristic of the variable directivity antenna wherein both the annular conductor 176 and the dielectric material 177 are provided as shown in FIG. 17A. On the other hand, the dashed line shows the characteristic of a variable directivity antenna wherein only the annular conductor 176 is provided.

Compared with the variable directivity antenna in which the direction of the variable directivity antenna which has dielectric material 177 does not have it, it is turned out that the directivity change quantity is increasing over a broad band at low frequencies around 29 GHz or less.

The ratio of the variable directivity antenna which has no dielectric material 177 if directivity change quantity observes the bandwidth used as 8 dB or more, the ratio of the variable directivity antenna which has the dielectric material 177 to a band being 22.2% as for a band, it turns out that 41.2% and bandwidth are expanded sharply. The band ratio means the ratio of the band width BW to the center frequency CF of the band where the directivity change quantity becomes 8 dB or more.

As mentioned above, it is possible to increase directivity change quantity over a larger band, maintaining a size equivalent to that of a non-directional antenna by arranging the dielectric material so that the end of the coaxial line may be touched around the antenna element.

### Embodiment 4

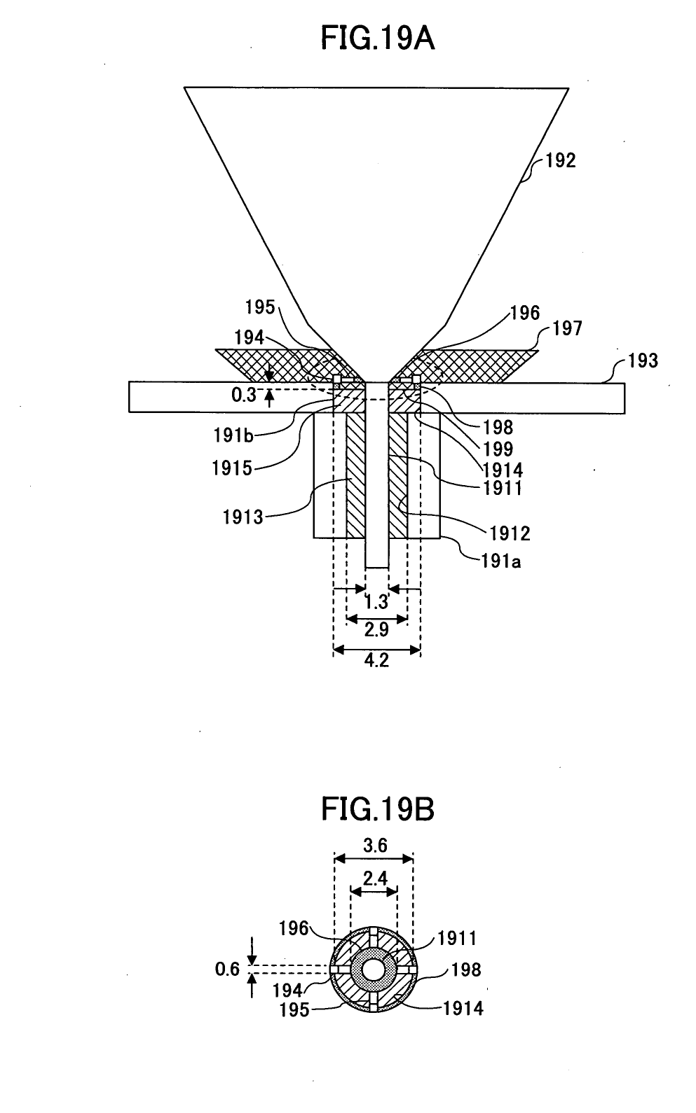

FIG. 19A and FIG. 19B show the composition of a variable directivity antenna in an embodiment of the invention. FIG. 19A is a cross-sectional view of this variable directivity antenna. FIG. 19B is a top view of the dashed-line part of the variable directivity antenna of FIG. 19A.

The variable directivity antenna of FIG. 19A is provided with the following. The coaxial line has the first and second coaxial lines 191a and 191b that comprise outer conductors 1912 and 1914 which have a different inside diameter from common inner conductor 1911. The non-directional antenna element is comprised of a rotator-like radiator 192 and a disc-like base plate 193, and was joined to the second coaxial line 191b for power supply. The directivity switching unit changes the directivity of this variable directivity antenna.

The directivity switching unit is provided with the following. Each short circuit unit 195 is arranged so that it might be provided in the second coaxial line 191b, radiator 192, and joint and the second inner conductor 1911 and outer conductor 1914 of coaxial line 191b might be connected in four directions. The switching units 194 are arranged in the middle of short circuit units 195.

Each switching unit 194 is a switch which is made of a PIN diode, and has the function to short-circuit electrically the second inner conductor 1911 and the outer conductor 1914 of the coaxial line 191b via the short circuit unit 195 when it is turned on and off.

In predetermined width and this embodiment, short circuit unit 195 has 0.6 mm, and, on the other hand, the thickness can disregard it.

In the variable directivity antenna of this embodiment, the diameter of the inner conductor 1911 of the first coaxial line 191a and the inside diameter of the outer conductor 1912 are equal to 1.3 mm and 2.9 mm. The dielectric material 1913 which is provided between the inner conductor 1911 and the outer conductor 1912 is air-(its specific inductive capacity is 1.0).

The inner conductor of the second coaxial line 191b is as common as inner conductor 1911 of the first coaxial line 191a, and the diameter is 1.3 mm. On the other hand, the inside diameter of the outer conductor 1914 is equal to 4.2 mm, which is larger than the inside diameter (=2.9 mm) of the outer conductor 1912 of the first coaxial line 191a.

The dielectric material 1915 which is provided between the inner conductor 1911 of the second coaxial line 191b and the outer conductor 1914 is not air but Teflon (registered trademark), and its specific inductive capacity is 2.0.

In this embodiment, the diameter of the lower end section which touches the second coaxial line 191b of radiator 192 is 1.3 mm equally to the diameter of inner conductor 1911 of the second coaxial line 191b. Various parameters, such as specific numeric values of the size of each of the above-mentioned component parts and their configurations, are determined based on the optimization design.

The variable directivity antenna of this embodiment is provided with the following. The annular conductor 196 is provided in the end of the second coaxial line 191b that touches the joint of the second coaxial line 191b and radiator 192 so that the perimeter of inner conductor 1911 of the second coaxial line 191b might be touched. The annular conductor 198 with a thickness of 0.3 mm provided so that the inner circumference of outer conductor 1914 of the second coaxial line 191b might be touched.

In the joint of the simultaneous track and the antenna element, the diameter of inner conductor 1911 of the second coaxial line 191b becomes large, and the inside diameter of outer conductor 1914 of the second coaxial line 191b becomes small so that clearly from FIG. 19B. As a result, it is possible to lower the cut-off frequency of the high-order radiation mode.

Specifically, the main cut-off frequency in the TE11 mode in the high-order radiation mode is equal to fc1=25.2 GHz at the location of in the second coaxial line 191b but it falls to fc2=18.5 GHz at the location of the junction.

As mentioned above, the cut-off frequency of the high-order radiation mode is lowered, the diameter of the inner conductor of the coaxial line being large in the joint of the coaxial line and an antenna element, and maintaining a size equivalent to that of a non-directional antenna by making the inside diameter of an outer conductor small.

Therefore, it is possible to increase directivity change quantity over a broad band so that a directive variable band may be expanded to the low frequency side.

The variable directivity antenna of this embodiment has the first dielectric material 197 provided so that the end of the second coaxial line 191b might be touched around the radiator 192.

The first dielectric material 197 is made of a liquid crystal polymer, and its specific inductive capacity is 3.0.

With this structure, it is possible to raise the higher-mode radiation ratio to the upper part of the contact part where the inner conductor 1911 and the outer conductor 1914 of the second coaxial line 191b are short-circuited by the short circuit unit 195 in order to increase the directivity change quantity.

The variable directivity antenna of this embodiment has the second same dielectric 199 (the liquid crystal polymer of the specific inductive capacity 3.0) that has the same dielectric constant as the first dielectric material 177 in the end of the second coaxial line 191b that touches the joint of the second coaxial line 191b and an antenna element.

In this embodiment, as shown in FIG. 19A, the second dielectric 199 is formed inside the annular conductor 198 provided so that the inner circumference of outer conductor 1914 of the second coaxial line 191b might be touched.

By making it this structure, change of the dielectric constant in the joint order of the second coaxial line 191b and an antenna element is lost, and it is possible to reduce the reflective loss of electromagnetic waves spread by the coaxial line.

The effect of the variable directivity antenna of this embodiment will be explained by using the variable directivity antenna of FIG. 4A as a comparative example.

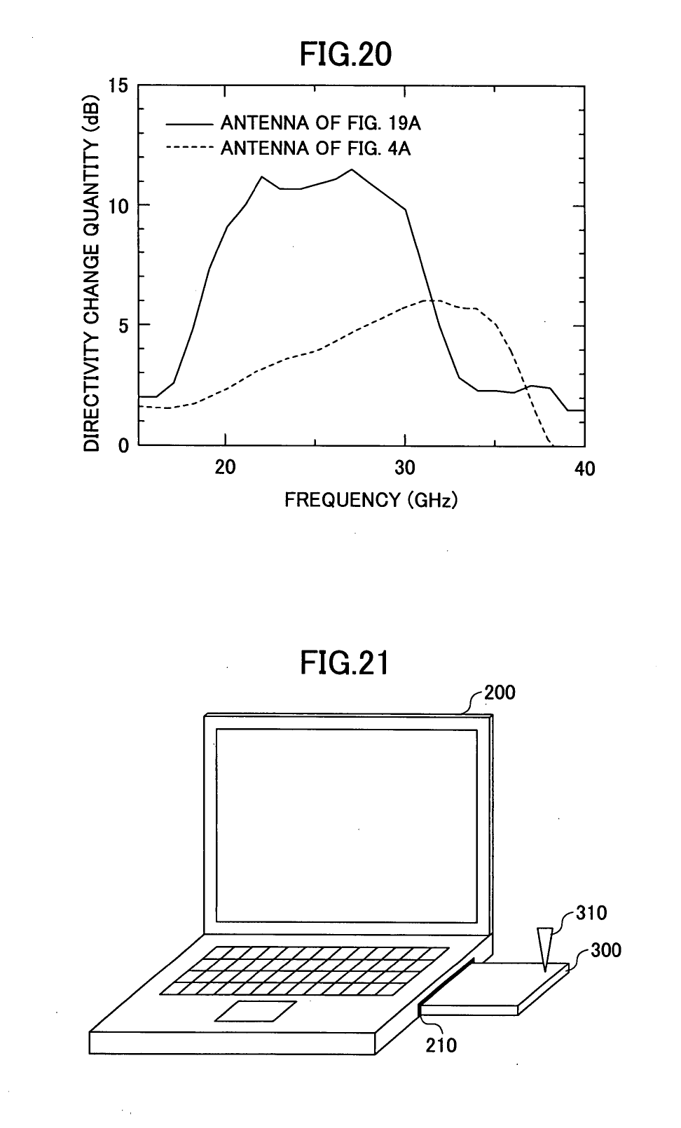

FIG. 20 is a diagram for explaining the frequency dependability of the directivity change quantity of each of the variable directivity antennas of FIGS. 4A and 19A.

In FIG. 20, the vertical axis expresses the directivity change quantity (dB), and the horizontal axis expresses the frequency (GHz). In the diagram of FIG. 20, the dashed line shows the characteristic of the variable directivity antenna of FIG. 4A, and the solid line shows the characteristic of the variable directivity antenna of the embodiment of FIG. 19A, respectively.

The maximum of the directivity change quantity increases as compared with the variable directivity antenna, and the variable directivity antenna of this embodiment turns out that directivity change quantity is increasing over a broad band so that clearly from FIG. 20.

As mentioned above, in the joint of the coaxial line and an antenna element, the diameter of the inner conductor of the coaxial line and the inside diameter of an outer conductor are changed, respectively.

By providing a dielectric material so that the end of the coaxial line may be touched around an antenna element, and losing change of the dielectric constant in the joint order of the coaxial line and an antenna element, it is possible to increase directivity change quantity over a broad band so that the cut-off frequency of the high-order radiation mode may be lowered, as a result a directive variable band may be expanded to the low frequency side, maintaining a size equivalent to that of a non-directional antenna.

### Embodiment 5

FIG. 21 is a diagram showing an example of an information processing device including any of the variable directivity antennas of the above-mentioned embodiments.

The information processing device 200 of FIG. 21 is a portable notebook-type personal computer (PC). A wireless-communication device 300 which has the variable directivity antenna 310 is inserted in the slot 210 provided in the information processing device 200.

Alternatively, the information processing device 200 may be any of an information processing device called desktop type PC, a mobile communication device, such as a personal digital assistant (PDA) and a cellular phone, and the wireless-communication device 300 and the variable directivity antenna 310 may be included in an information processing device 200.

The information processing device 200 can transmit and receive information among other devices which were connected on wireless-communication to networks, such as the Internet and intranet, by the wireless-communication device 300, and are similarly connected to the network.

Alternatively, the information processing device 200 may perform the transmitting/receiving of other devices and information directly, without minding a network.

The information transmitted and received among other devices is transmitted and received in the form of an electromagnetic wave signal by variable directivity antenna 310 provided in wireless-communication device 300.

Since the directive variable band crosses variable directivity antenna 310 of the invention to a broad band, in the system that it can be used with a broad band wireless communication system, and the frequency hopping in a very a broad band is required, it is advantageous at the point that the communication quality in each frequency used is maintainable.

(Modifications)

As described in the foregoing, the embodiments of the variable directivity antenna using the antenna element, similar to the disc-cone antenna which is comprised of a disc-like base plate and a rotator-like radiating element have been explained. However, this invention is not limited to the above-described embodiments. This invention is also applicable to a bi-conical antenna comprised of two conical antenna elements which are arranged so that they face each other. It is possible for this invention to acquire the same effects as in the above-described embodiments, even in such a case.

Moreover, even when the shape of the radiator is not symmetrical about an axis of rotation of the radiator and perfect indirectivity of the antenna is not provided, as in a disc mono-pole antenna in which a pole-like radiator is arranged to be perpendicular to the surface of a base plate, the application of this invention thereto enables the directivity change quantity to be increased over a broad band and it is possible to change the directivity.

This invention is not limited to the above-described embodiments, and variations and modifications may be made without departing from the scope of this invention.

This application is based on and claims the benefit of priority of Japanese patent application No. 2006-229636, filed on Aug. 25, 2006, the entire contents of which are hereby incorporated by reference.

What is claimed is:

1. A variable directivity antenna comprising:
an antenna element including a pole-like or rotator-like radiator;
a coaxial line supplying power to the antenna element;
a directivity switching unit provided in a junction between the antenna element and the coaxial line to change a directivity of the variable directivity antenna,
wherein at least one of an inside diameter of an outer conductor of the coaxial line in contact with the junction and a diameter of an inner conductor of the coaxial line in contact with the junction is changed to change a gain of the variable directivity antenna.

2. The variable directivity antenna according to claim 1, wherein at least one of an annular conductor in contact with an inner circumference of the outer conductor and an annular conductor in contact with an outer circumference of the inner conductor is provided to change the gain of the variable directivity antenna.

3. The variable directivity antenna according to claim 1, wherein the antenna element is provided so that a diameter of a surface in contact with the junction is larger than a diameter of the inner conductor of the coaxial line, to change the gain of the variable directivity antenna.

4. The variable directivity antenna according to claim 1, wherein a first dielectric which comes in contact with an end of the coaxial line is provided in a circumference of the radiator to change the gain of the variable directivity antenna.

5. The variable directivity antenna according to claim 4, wherein a second dielectric which has a dielectric constant different from a dielectric constant between the outer conductor and the inner conductor of the coaxial line is provided at the end of the coaxial line to change the gain of the variable directivity antenna.

6. The variable directivity antenna according to claim 5, wherein the dielectric constant of the second dielectric is equal to a dielectric constant of the first dielectric.

7. The variable directivity antenna according to claim 1, wherein the directivity switching unit comprises a linear short circuit unit which is provided in the junction to short-circuit the inner conductor and the outer conductor of the coaxial line.

8. The variable directivity antenna according to claim 7, wherein any of the entire short circuit unit and a width or thickness of a part of the short circuit unit has a predetermined size.

9. A variable directivity antenna comprising:
an antenna element including a pole-like or rotator-like radiator;
a coaxial line supplying power to the antenna element; and
a directivity switching unit provided in a junction between the antenna element and the coaxial line to change a directivity of the variable directivity antenna,
wherein a dielectric which comes in contact with an end of the coaxial line is provided in a circumference of the radiator to change a gain of the variable directivity antenna.

10. A variable directivity antenna comprising:
an antenna element including a pole-like or rotator-like radiator;
a coaxial line supplying power to the antenna element; and
a directivity switching unit provided in a junction between the antenna element and the coaxial line to change a directivity of the variable directivity antenna,
wherein the directivity switching unit comprises a linear short circuit unit which is provided in the junction to short-circuit an inner conductor and an outer conductor of the coaxial line, and
wherein any of the entire short circuit unit and a width or thickness of a part of the short circuit unit has a predetermined size.
